(19) United States
(12) Patent Application Publication
(10) Pub. No.: US 2015/0161349 A1
(43) Pub. Date: Jun. 11, 2015

(54) SYSTEM AND METHOD OF USE FOR SOCIAL ELECTRONIC HEALTH RECORDS

(71) Applicant: Juan I. Rodriguez, Lewisville, TX (US)

(72) Inventor: Juan I. Rodriguez, Lewisville, TX (US)

(21) Appl. No.: 14/563,075

(22) Filed: Dec. 8, 2014

Related U.S. Application Data
(60) Provisional application No. 61/914,355, filed on Dec. 10, 2013.

(51) Int. Cl. G06F 19/00

(52) U.S. Cl. CPC G06F 19/3443; G06Q 50/01

(57) ABSTRACT

In the preferred embodiment of the present invention, a method for exchanging personalized electronic health records for a viewing user of a social network is disclosed, the method comprising: (1) storing patient health information by one or more users of a social network; (2) accessing relationship data for the one or more users, the relationship data specifying medical links between users in the social network; (3) associating at least one medical link with at least one user to produce consolidated medical data; (4) aggregating consolidated data having one or more common medical links to produce aggregated consolidated data, wherein the aggregated consolidated data identifies at least one medical link, a user of the social network with the medical link, and one or more other users of the social network who also have the same medical link; and (5) creating social networking links based on the aggregated consolidated data.

### RELATED APPLICATIONS

This application claims priority to U.S. Provisional Application No. 61/914,355 filed Dec. 10, 2013. The entire contents of the above application are hereby incorporated by reference as though fully set forth herein.

### FIELD

The present invention relates to the field of electronic health records. More specifically, the present invention relates to creation and use of electronic health records through social media.

### BACKGROUND

An Electronic Health Record, known hereafter as “EHR” is a real-time, patient-centered record. EHRs make information available instantly, whenever and wherever it is needed while bringing together in one place everything about a patient's health. EHRs can contain information about a patient's medical history, medical conditions, medications, immunization dates, allergies, radiology images, and lab and test results.

Patients face significant costs when searching for health-related information and products. They either have to visit physical places, spend too much time conducting online research in a myriad of websites or call multiple places to describe their symptoms and inquire about possible course of treatments. In any case the process is fairly time consuming and costly.

Although, there is no replacement for a one-on-one relationship with a qualified health care professional or a substitute for professional medical advice, diagnosis or treatment, there is a need for an application that is intended primarily for informational purposes on health care treatments in one single place. This would reduce searching costs and improving the efficiency of collecting information while tracking the progress of user treatments. It should also empower patients with the tool to sift through large amounts of health related data and thereby keeping patients well-informed prior to a qualified health care professional visit.

With the recent explosion of Internet based social networking systems, patients often seek out the guidance an advice of others around the world through these social networks for the treatment of their medical conditions. As such, there is a need for an application that integrates with various social networking platforms such as Facebook, Twitter, LinkedIn etc. in a private and secure manner to: (1) allow the patients to search for health care providers based on reviews or patient improvements; (2) allow the patients to search for medications, supplements, treatments, etc. based on their impact on the other patients using the same medications, treatments etc.; (3) allow patients to search for other patients suffering from their same medical condition; (4) allow patients to search for other patients seeing the same health care provider; (5) allow patients to search for other patients taking the same medications; and (6) compare the side effects or progress obtained by different treatments.

### BRIEF SUMMARY OF THE INVENTION

The present invention seeks to meet these needs by providing a software application and method of use designed to collect, process, store, and distribute health related information in one single Internet website and mobile application to all subscribed members by creating social networking links. Generally, an EHR is a longitudinal electronic record of patient health information generated by one or more encounters in any care delivery setting. Included in this information are patient demographics, progress notes, problems, medications, vital signs, past medical history, immunizations, laboratory data and radiology reports. The EHR automates and streamlines the clinician's workflow. The EHR has the ability to generate a complete record of a clinical patient encounter—as well as supporting other care-related activities directly or indirectly via interface—including evidence-based decision support, quality management, and outcomes reporting.

The health information of the present invention may be collected from an EHR or an individual user through a social network community that is brought together by a common goal, which is in this case to reduce health information search costs. The present invention is known as “Social EHR” and it is a tool for patients to establish connections and exchange health information, taking into account their own privacy and security. In terms of health information privacy rights, all subscribers can restrict the health related information to be shared. In other words, the subscribers will let the application know the information they do not want to share.

In the preferred embodiment of the present invention, a method for exchanging personalized electronic health records for a viewing user of a social network is disclosed, the method comprising: (1) storing patient health information by one or more users of a social network; (2) accessing relationship data for the one or more users, the relationship data specifying medical links between users in the social network; (3) associating at least one medical link with at least one user to produce consolidated medical data; (4) aggregating consolidated data having one or more common medical links to produce aggregated consolidated data, wherein the aggregated consolidated data identifies at least one medical link, a user of the social network with the medical link, and one or more other users of the social network who also have the same medical link; and (5) creating social networking links based on the aggregated consolidated data.

In another embodiment of the present invention, a system for displaying a news feed is disclosed, the system comprising: (1) a social network environment; (2) a module configured to access relationship data for the one or more users, the relationship data specifying a plurality of medical links between users in the social network environment; (3) a module configured to monitor the plurality of medical links between users in the social network environment; (4) a storage medium for storing the plurality of medical links in a database; (5) a module configured to generate a plurality of news items from one or more medical links, wherein one or more of the medical links is for presentation to one or more viewing users and relates to a medical link that was entered by another user; and (6) a module configured to display a personalized news feed for a user created by identifying at least one action associated with a common medical link, a user of the social network with the common medical link, and one or more other users of the social network who also have the same medical link.

In an additional embodiment of the present invention, a computer readable medium having embodied thereon a program is disclosed, the program being executable by a processor for performing a method for exchanging personalized electronic health records for a viewing user of a social network, the method comprising: (1) storing patient health information by one or more users of a social network; (2) accessing relationship data for the one or more users, the relationship data specifying medical links between users in the social network; (3) associating at least one medical link with at least one user to produce consolidated medical data; (4) aggregating consolidated data having one or more common medical links to produce aggregated consolidated data, wherein the aggregated consolidated data identifies at least one medical link, a user of the social network with the medical link, and one or more other users of the social network who also have the same medical link; and (5) creating social networking links based on the aggregated consolidated data.

### BRIEF DESCRIPTION OF THE DRAWINGS

FIG. 1. Master Flowchart for the social EHR of the present invention.

FIG. 2. “Login” module flowchart for the social EHR of the present invention.

FIG. 3. “Sign Up” module flowchart for the social EHR of the present invention.

FIG. 4. “Health Issues” module flowchart for the social EHR of the present invention.

FIG. 5. “Health Care Providers” module flowchart for the social EHR of the present invention.

FIG. 6. “Health Care Options Select” module flowchart for the social EHR of the present invention.

FIG. 7. “Add Health Care Options Impact” module flowchart for the social EHR of the present invention.

FIG. 8. “Find Treatments” module flowchart for the social EHR of the present invention.

FIG. 9. “Health Care Provider Select” module flowchart for the social EHR of the present invention.

FIG. 10. “Health Care Options” module flowchart for the social EHR of the present invention.

FIG. 11. “Find Health Care Providers” module flowchart for the social EHR of the present invention.

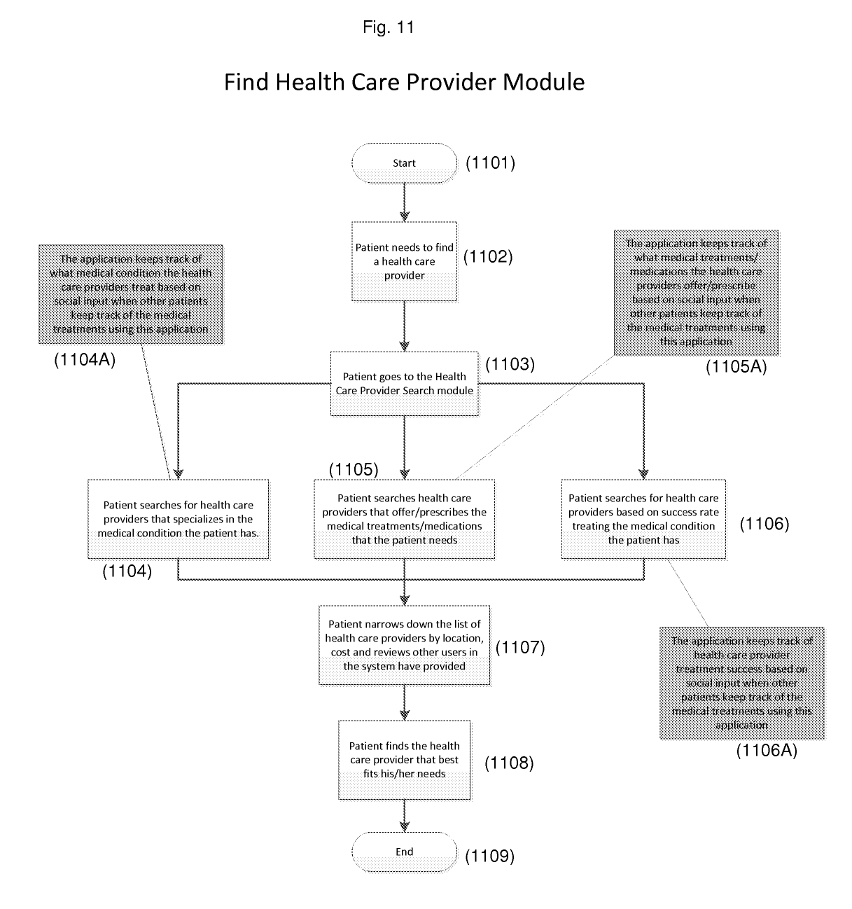

FIG. 12. “Find People” module flowchart for the social EHR of the present invention.

FIG. 13. “News Feed” module flowchart for the social EHR of the present invention.

FIG. 14. “Automatic Social Suggest” module flowchart for the social EHR of the present invention.

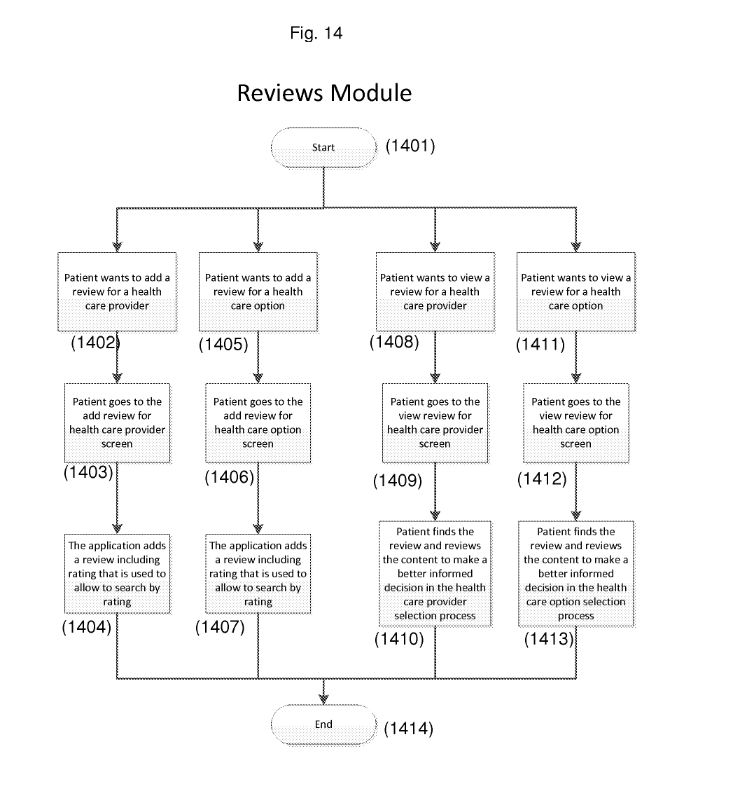

FIG. 15. “Reviews” module flowchart for the social EHR of the present invention.

### DETAILED DESCRIPTION

For the purposes of this application, the term “diagnosis code” is synonymous with the patient's medical condition.

For the purposes of this application, the term “medical professional” may also mean health care providers in general.

For the purposes of this application, the term “Reviews” may also mean comments left by users.

For the purposes of this application, the term “users” is interchangeable with “subscribers” and “patients.”

For the purposes of this application, the term “Health Care Option” may denote a medical treatment, medication, diet, medical protocol or supplement.

The Social EHR software system of the present invention is internet or mobile application based using website and mobile applications formats similar to those used in the prior art. The following description indicates the current preferred embodiment of the present invention but is in no way intended to limit the present invention to these parameters and/or descriptions.

In the preferred embodiment, the “Welcome Page” will provide the users with high level information of what Social EHR is and allow the users to sign up or login. Downloads of the software necessary to use the invention on mobile devices will be readily available on the Welcome Page.

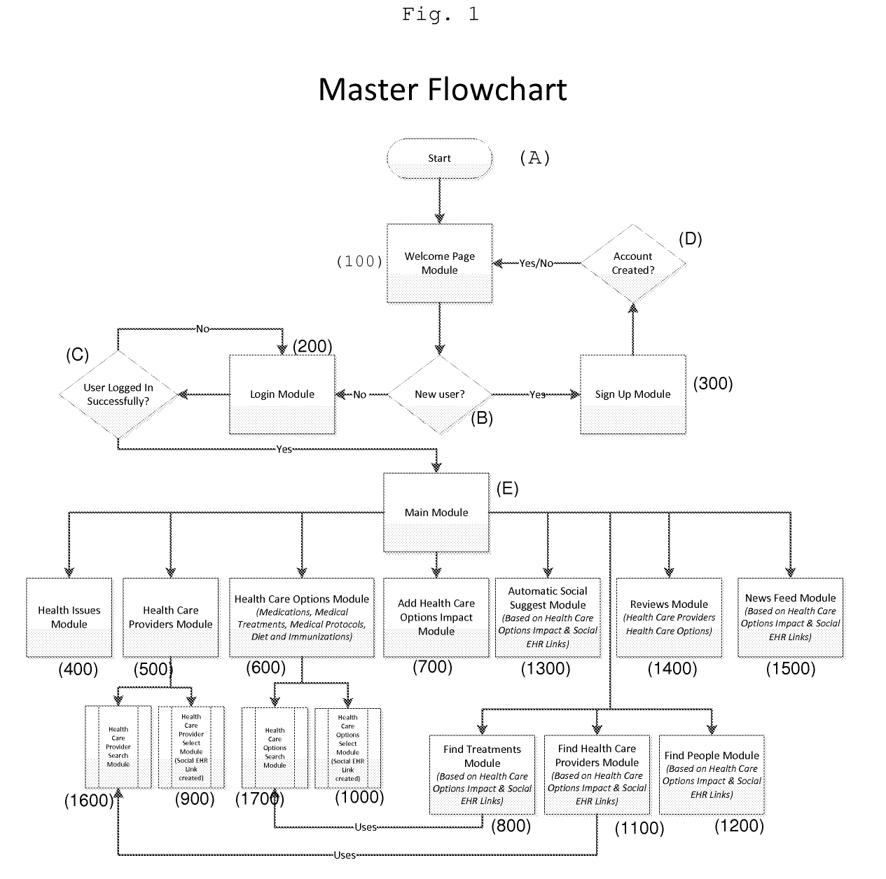

Turning to FIG. 1, in the preferred embodiment of the present invention the user starts at “Welcome Page” module 100. If the user is not a new user to the system as shown in B, then the user will access a “Login” module 200. If the user is successfully logged in as shown in C, then the user will be able to access a “Main” module E. If the user is a new user to the system, the user is directed to a “Sign Up” module 300 to create a social networking login, such as Facebook, to create an account as shown in D. After account creation, the user is directed back to the “Welcome Page” module 100 and will proceed with the “Login” module 200 accordingly. The “Main” module E has a series of sub modules, in the preferred embodiment of the present invention these modules are known as “Health Issues” 400; “Health Care Providers” 500; “Health Care Options” 600; “Add Health Care Impact” 700; “Find Treatments” 800; “Health Care Provider Select” 900; “Health Care Options Select” 1000; “Find Health Care Providers” 1100; “Find People” 1200; “Automatic Social Suggest” 1300; “Reviews” 1400; “News Feed” 1500; “Health Care Provider Search” 1600; and “Health Care Options Search” 1700.

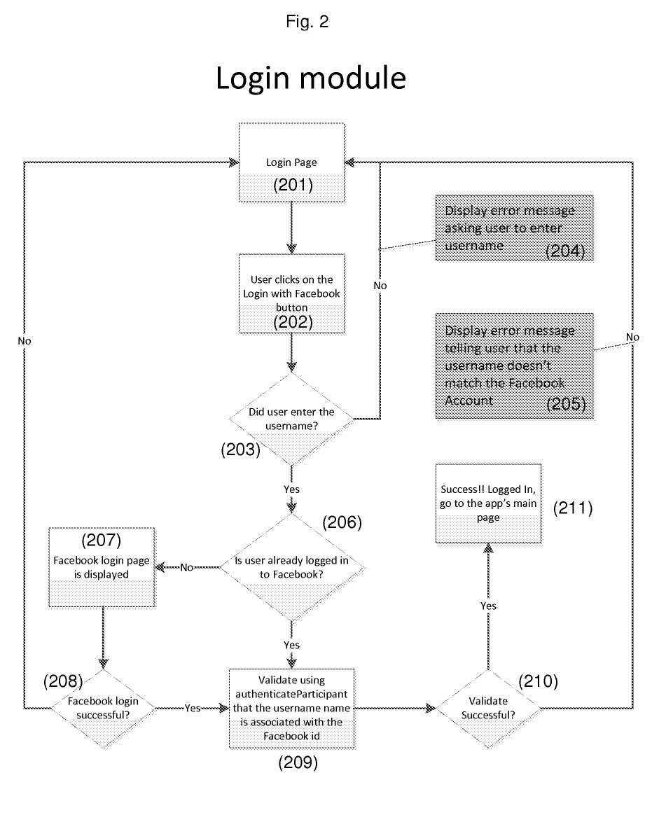

The “Login” module 200 is shown further in FIG. 2. The Login page 201 allows the user to login to Social EHR by validating their credentials using their social networking account and by matching the username to the social networking account ID in the Social EHR database. In 202 the user clicks on the Login with a social network, such as Facebook for example, button. In 203, the user enters their username. If the user does not enter a username, an error message is displayed as shown in 204. If the user is already logged into the social network as shown in 206, the login page for the social network is displayed as in 207. If the login is successful as shown in 208, the username is validated as shown in 209. If the validation is successful as shown in 210, the user is logged in and may go to the website or mobile applications main page as shown in 211. If the validation is not successful, an error message is displayed as shown in 205.

If the user does not have the requisite social networking account, the user is directed to the sign up page of the “Sign Up” module 300 as shown in 301. The user selects the create account button as shown in 302. If the user has entered all the required fields for sign up as required in 303, the system checks to see if the user is already logged into the social networking site as shown in 305. If the user is not logged in, the social networking site login is displayed as shown in 306. If the social networking login is successful as shown in 307, a new account with the Social EHR is created as shown in 308. Once the account is created, a confirmation email is sent to the user and the user is redirected to the login page as shown in 309.

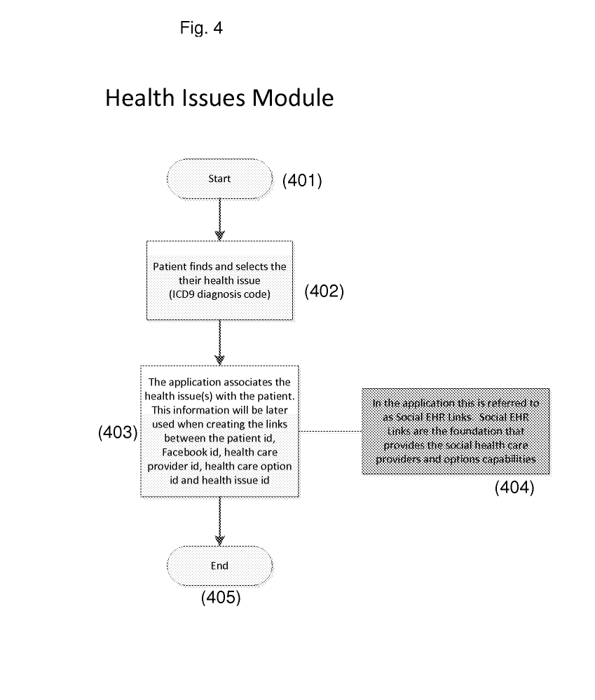

The “Health Issues” module 400 shown in FIG. 4 allows to view and edit the user's health issues. The users can view and select from a list of one or more diagnosis codes for their disease(s) as shown in 402. The diagnosis code(s) selected will then be saved in the database and associated with the user id as shown in 403. Users may edit and remove their diagnosis codes. When the user enters the diagnosis code, the app will automatically recommend medications, health care providers, health care options and a list other people's Facebook profiles that have the same medical condition or that receive treatment from the same health care provider as shown in 404. Users may also search for the medications, treatment, supplements, medical protocols that others are using for their medical condition (diagnosis code). Users may further search for the health care providers that others are using for their medical condition (diagnosis code). Users may also search for people that are being treated by their health care providers for the same medical condition or other medical conditions. The Social EHR provides history for the data that the user entered. When the user enters the diagnosis code, the app will automatically recommend medications, health care providers, treatments and a list other user's social network profiles that have the same medical condition or that receive treatment from the same health care provider through the “Automatic Social Suggest” module 1300 as discussed further below.

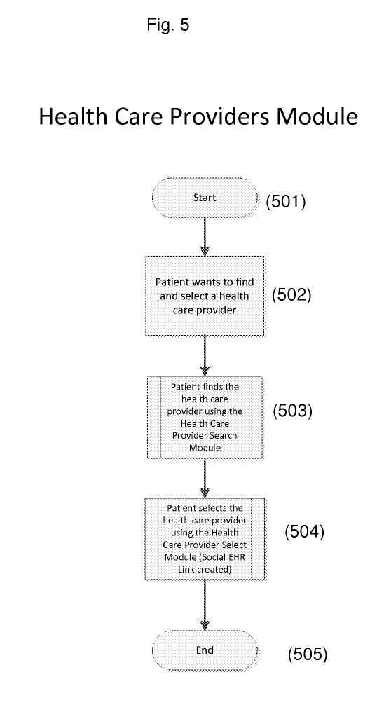

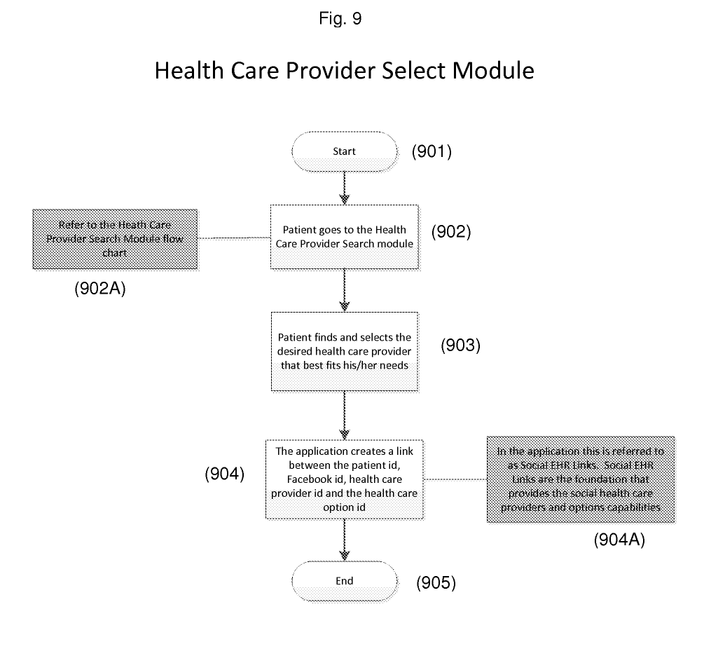

Turning to FIG. 5, the user may access the “Health Care Providers” module 500 where users can add (select), edit or delete medical professionals. If the user wants to find and select a health care provider in 502, the user may find the health care provider using the “Health Care Provider Search” module 1600 as shown in 503. The user may select the health care provider using the “Heath Care Select” module 900 (shown in further detail in FIG. 9) as shown in 504. The application help users to find health care providers that other users have used to treat the diagnoses they chose. Users will be able to read ratings and reviews from others as well as adding their own reviews and ratings. In the database, there is an association between diagnosis codes and users. There is also an association between users and health care providers. Each one of these health care providers can have reviews and ratings. Using this data the application displays the most popular health care providers to the users based on what other users have entered through their accounts. Users can search health care providers by name, address and ratings.

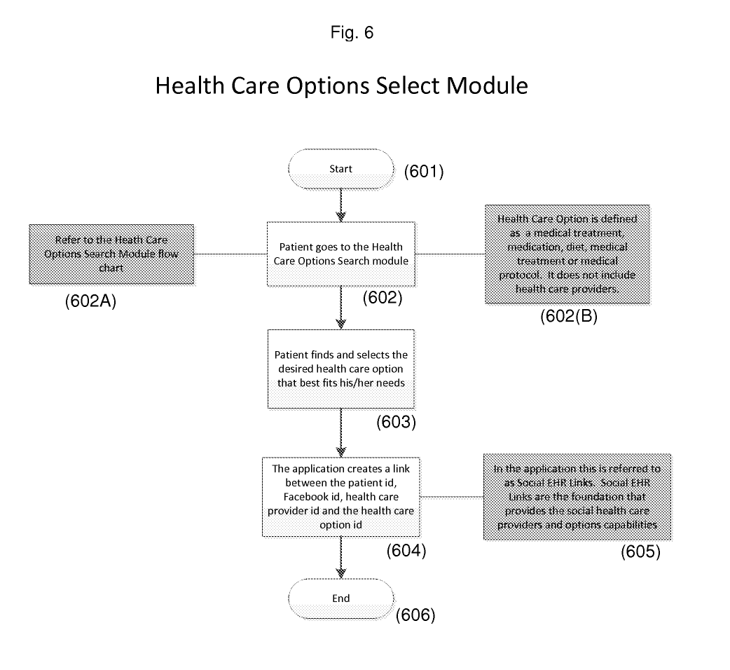

The “Health Care Options Select” module 600 is shown in FIG. 6. The user accesses the module in 602 and may search as shown in 602(A) by using the “Health Care Options Search” module 1700. As shown in 602(B), the health care option may be a medication, medical treatment, diet or medical protocol but does not include health care providers. The user finds and selects their desired health care option in 603. The Social EHR creates a link between the user ID, social network ID, health care provider ID and the health care option ID as shown in 604. This process is referred to as Social EHR links which as shown in 605 and is the foundation that provides the health care providers and health care options social capabilities.

The information collected on health care options may be arranged in a table format and provide relevant information like name, reviews and ratings, protocol start date, users can collaborate with others by clicking on the social network link associated to the reviews, etc. The Social EHR will help users all over the world to easily find which medical treatments and protocols have been rated and reviewed by other users to be the most helpful. Users will be able to read ratings and reviews from others as well as adding their own reviews and ratings. In the Social EHR database, there is an association between diagnosis codes and users. There is also an association between users and health care options. Each one of these health care options can have reviews and ratings. Using this data the Social EHR displays the most popular health care options to the users based on what other users have entered through their accounts.

The Social EHR may have a window that allows the user to see a list of ratings and reviews for any given health care option that shows the following information: (1) how many users rated the health care option from 1 to 5 stars; (2) the total amount of reviews; (3) the ability to mark reviews as helpful or not helpful; (4) the total amount of people that found a specific review helpful or not helpful; (5) the ability to mark a review as inappropriate and a comment can be added; and (6) the ability to share in their social network timeline or feed or by social network private message reviews for health care options.

Users will be able to find out who else had the same side effects to a medical treatment and protocol and contact those users through the social network. Users may keep track of (1) side effects of the different medical protocol; (2) the effectiveness of the medical treatments and protocols; and (3) the effectiveness of the different medical treatments and protocols by being able to see how others reacted to the medical treatments and protocols. The Social EHR may also offer charts that will provide a visual alternative to progress made by the user in different medical treatments and protocols as well as provide history for the data that the user entered.

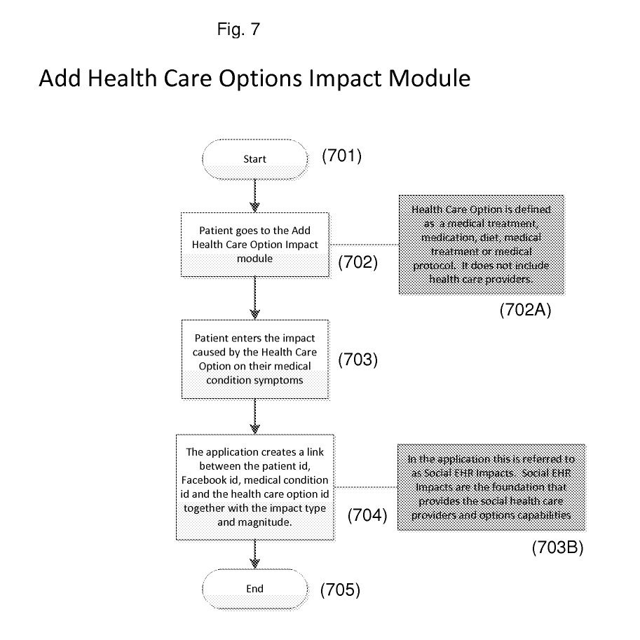

The “Health Care Options Impact” module 700 is shown in FIG. 7. The user accesses the module in 701 and the health care option may be a medical treatment, medication, diet or medical protocol as shown in 701(A). The user enters the impact caused by their health care option on their medical condition symptoms as shown in 702. The Social EHR creates a link between the user ID, social network ID, medical condition ID, the health care option ID with the impact type and magnitude as shown in 703. This process is referred to as Social EHR links which as shown in 703(B) and is the foundation that provides the health care providers and health care options social capabilities. The Social EHR allows the users to add, retrieve and remove their user's impact of their health care providers and health care options in their health and provides history for the data that the user entered.

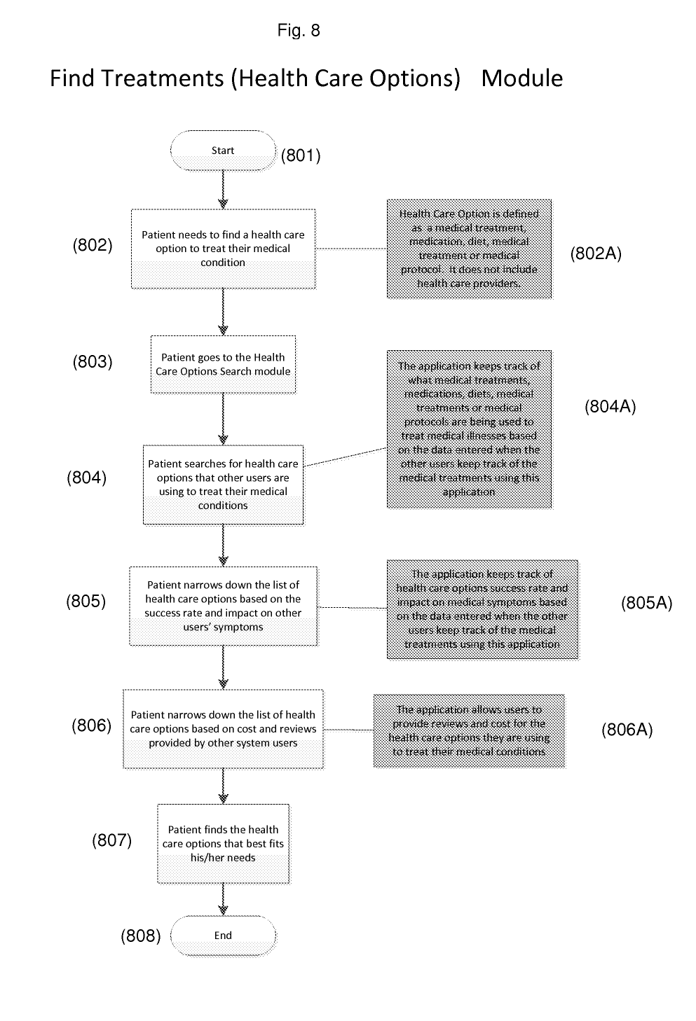

Turning to FIG. 8, the “Find Treatments” module 800 is shown. If the user wants to find a health care option to treat their medical condition(s) as shown in 802, the user accesses the module in 803 and searches for the health care options that other users are using to treat their medical conditions 804. The user may narrow down the list of health care options based on the success rate and impact of the other user's symptoms as shown in 805. The user further narrows down the list of health care options based on cost and reviews provided by other users as shown in 806. Ultimately, the user finds the health care option that best fits his/her needs as shown in 807. As noted in 802(A), the health care option may be a medical treatment, medication, diet or medical protocol. The Social EHR tracks what health options are being used to treat medical illnesses based on the data entered by the users as shown in 804(A). Further, the Social EHR tracks health care options success rates and impact on medical symptoms based on the data entered by the users as shown in 805(A). Finally, the Social EHR allows the users to provide reviews and costs for health care options as shown in 806(A).

The “Health Care Provider Select” module 900 is shown further in FIG. 9. After the user has accessed the “Health Care Provider Search” module 1600 as shown in 902 and 902(A). The user selects the health care provider in 903. The Social EHR creates a link between the user ID, social network ID, health care provider ID and the health care option ID as shown in 904. This process is referred to as Social EHR links which as shown in 904(A) and is the foundation that provides the health care providers and health care options social capabilities.

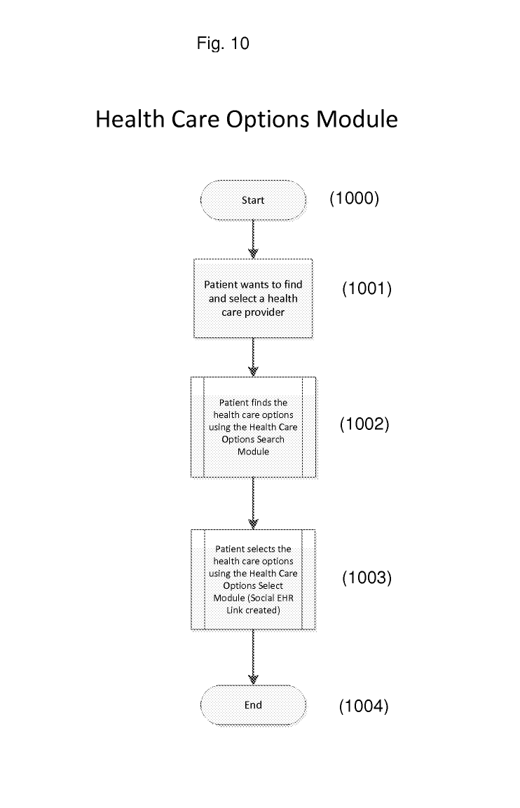

In FIG. 10, the “Health Care Options Select” module 1000 is shown wherein if the user wants to find and select a health care provider based on the health options they provide in 1001, the user accesses the “Health Care Options Search” module 1700 as shown in 1002. The user selects the health care option as shown in 1003.

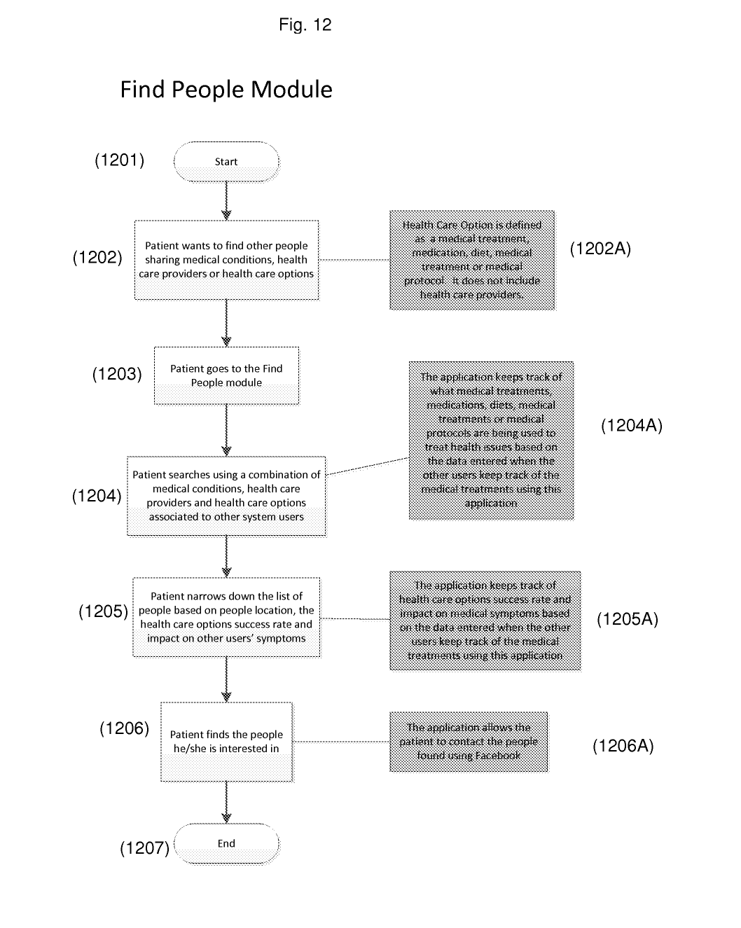

The “Health Care Provider” module 1100 is shown in FIG. 12. When the user wants to find a health care provider in 1102, the user accesses the module in 1103 and the user may search using the following parameters: (1) health care providers that specialize in medical condition of user as shown in 1104; (2) health care providers that provide health care options the user desires as shown in 1105; or (3) health care providers based on the success rate of treating the medical condition of the user as shown in 1106. The Social EHR tracks what health care providers are providing health care options for certain medical conditions based on the data entered by the users as shown in 1105(A). Finally, the Social EHR tracks treatment success by health care providers based on the data entered by users as shown 1106(A). The user may then narrow down the list of health care providers as shown in 1107 based on search criteria used and ultimately finds the health care provider that best fits his/her needs as shown in 1108. Social EHR allows users to rate and add reviews for health care providers, which will help users all over the world now to easily find which health care providers have been rated and reviewed by other users and to determine which health care providers may be the most helpful. Further, it allows users to be able to share in their social network timeline or by private message reviews for health care providers through the social network private messaging system.

The information collected on health care providers may be arranged in a table format and provide relevant information like name, reviews and ratings, treatment start date such that users can collaborate with others by clicking on the social networking link associated to the reviews and other users, etc. The Social EHR will help users to find health care providers that other users have used to treat the diagnoses they chose. Users will be able to read ratings and reviews from others as well as adding their own reviews and ratings. In the Social EHR database, there is an association between diagnosis codes and users. There is also an association between users and health care providers. Each one of these health care providers can have reviews and ratings. Using this data the Social EHR displays the most popular health care providers to the users based on what other users have entered through their accounts.

Social EHR may have a window that allows the user to see a list the ratings and reviews for any given doctor that shows the following information: (1) how many users rated the health care providers from 1 to 5 stars; (2) the total amount of reviews; (3) the ability to mark reviews as helpful or not helpful; (4) the total amount of people that found a specific review helpful or not helpful; (5) the ability to mark a review as inappropriate and a comment can be added; and (6) the ability to share in their social network timeline or feed or by social network private message reviews for health care providers.

Additionally, health care providers can create an account and see the reviews and ratings people has added about them. Health care providers can see what treatments, protocols, supplements, diets and medications are the most popular, see the ratings and reviews. Health care providers can search medical diseases by diagnostic code. Health care providers may contact other health care providers by searching for them and health care providers can find out what other health care providers have had the most success with their patients by looking at their ratings and reviews. Health care providers can collaborate with other health care providers that have similar type of patients by searching by the diagnosis codes and then contacting them by social network for which the application provides the link to the other health care providers social network profile page.

“Find People” module 1200 is shown in FIG. 12. When the user wants to find other users sharing medical conditions, health care providers or health care options as shown in 1202, the patient accesses the module in 1203 where they search using a combination of medical conditions, health care providers and health care options associated other users in 1204. The user is able to narrow down the list of users based on location, health care options success rate and health care impact in 1205. Social EHR tracks the health care options that users are using for certain medical conditions based on the data entered by the users as shown in 1204(A). Finally, Social EHR tracks treatment success of health care options based on the data entered by users as shown 1206(A). The user may then narrow down the list of health care providers as shown in 1205 based on search criteria used and ultimately finds the health care provider that best fits his/her needs as shown in 1207.

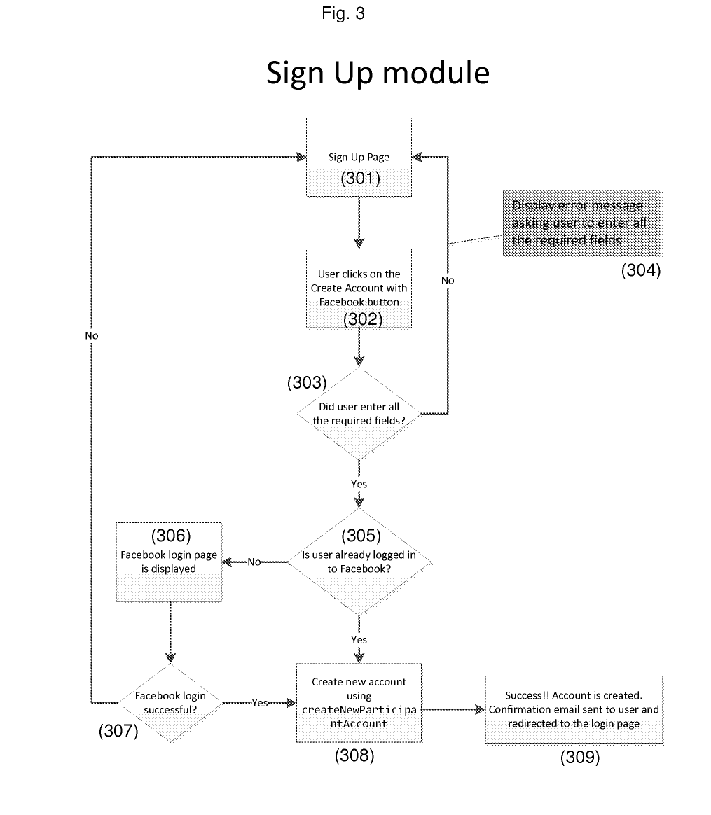

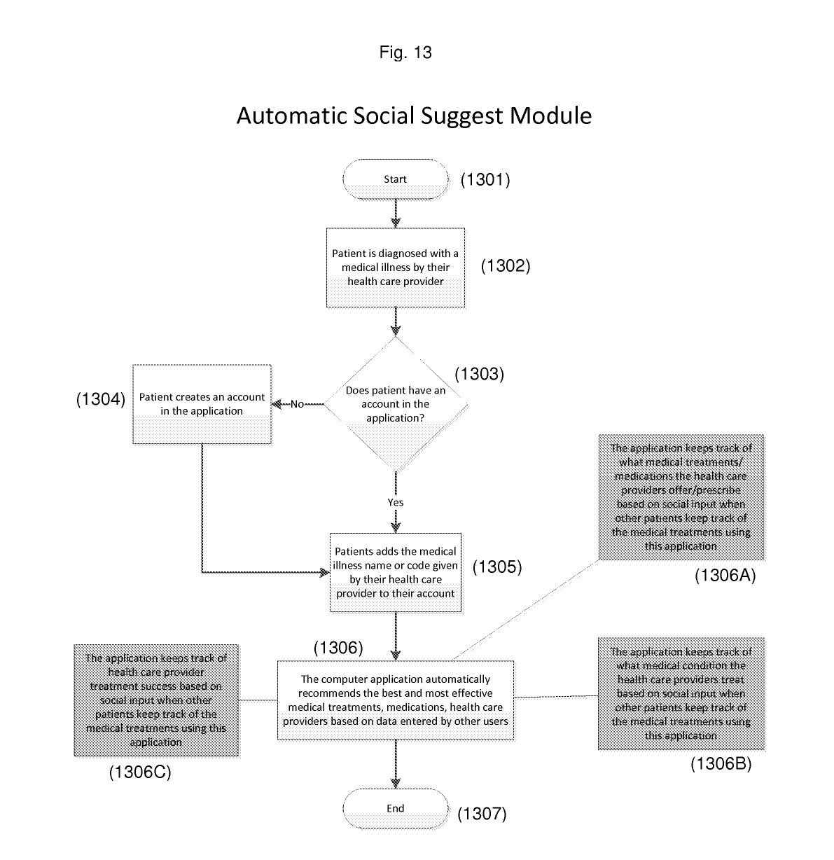

A key feature of the present invention is shown in FIG. 13 as the “Automatic Social Suggest” module 1300. If the user has a diagnosis for a medical condition as shown in 1302, the user may either log in to the social EHR as shown in 1403 or create an account in 1404 using the “Sign Up” module 300 shown further in FIG. 3. The user accesses the “Health Issues” module 400 to enter their medical condition as shown in 1405. Social EHR then automatically recommends the best and most effective health care options for the user in 1406. Social EHR tracks what health care options are offered for certain medical conditions based on the data entered by the users as shown in 1306(A). Social EHR tracks what health care providers are providing what health care options for certain medical conditions based on the data entered by the users as shown in 1306(B). Further, Social EHR tracks treatment success by health care providers based on the data entered by users as shown 1306(C).

The “Reviews” module 1400 tracks reviews for health care providers and health care options. If the user want to add a review for a health care provider as shown in 1402, the user accesses the add review of health care provider screen as shown in 1403. Social EHR adds the review and includes a rating that is used to search by rating in 1404. If the user want to add a review for a health care options as shown in 1405, the user accesses the add review of health care provider screen as shown in 1406. Social EHR adds the review and includes a rating that is used to search by rating in 1407. If the user want view a review for a health care provider as shown in 1408, the user accesses the view review health care provider screen as shown in 1409. The user reads the review to make an informed decision in selecting a health care provider as shown 1410. If the user want view a review for a health care option as shown in 1411, the user accesses the view review health care option screen as shown in 1412. The user reads the review to make an informed decision in selecting a health care option as shown 1413.

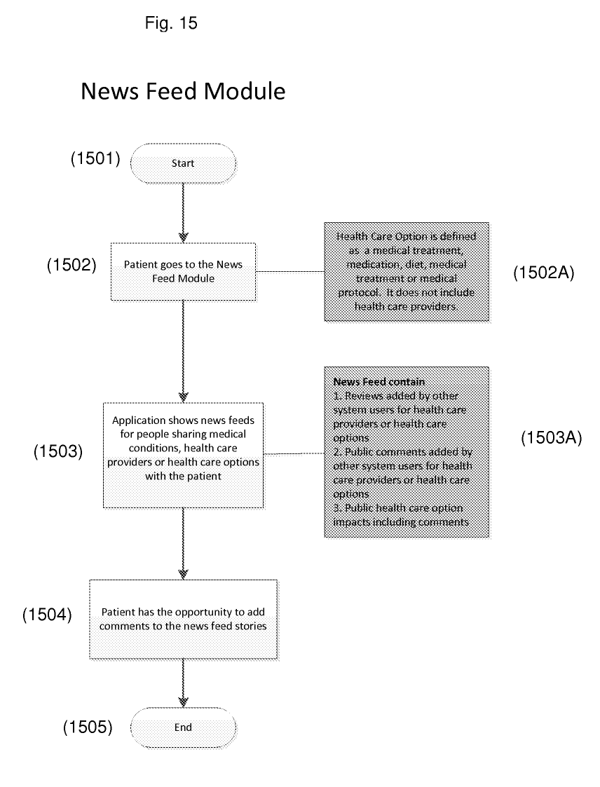

Turning to FIG. 15, the “News Feed” module 1500 is shown. The user accesses the module in 1502 and the Social EHR shows news feeds for users sharing medical conditions, health care providers or health care options with the user in 1503. The user then has the opportunity to add comments to the news feed stories in 1504. The news feed generally contains, but is not limited to, reviews and comments added by other users for health care providers or health care options as well as health care option impacts with comments as shown in 1303(A).

Other modules not shown in the figures may be implemented with the Social EHR. For example, the user may access a “manage medical items” screen wherein the users may manage their medical items like medications, supplements, medical treatments, medical protocols and diet as well as allow the the users to add, retrieve, and delete their medical items and provide a history for the data that the user entered.

There may be a module dedicated to tracking user medications and supplements where user can also add and view reviews, add dosages and view history. The information collected on medications and supplements may be arranged in a table format and provide relevant information like name, reviews and ratings, protocol start date, users can collaborate with others by clicking on the social network link associated to the reviews, etc. Social EHR will help users all over the world to easily find which medications and supplements have been rated and reviewed by other users to be the most helpful. Users will be able to read ratings and reviews from others as well as adding their own reviews and ratings. In the Social EHR database, there is an association between health care options and users. Each one of these health care options can have reviews and ratings. Using this data the Social EHR displays the most popular health care options to the users based on what other users have entered through their accounts.

Social EHR may have a window that allows the user to see a list the ratings and reviews for any given health care option that shows the following information: (1) how many users rated health care options from 1 to 5 stars; (2) the total amount of reviews; (3) the ability to mark reviews as helpful or not helpful; (4) the total amount of people that found a specific review helpful or not helpful; (5) the ability to mark a review as inappropriate and a comment can be added; and (6) the ability to share in their social network timeline or feed or by social network private message reviews for the health care options. Social EHR may suggest the most relevant health care options. Most relevant is defined by how many reviews, the rating and how many people found the reviews useful. Users will be able to see the history of the social interactions that were made by viewing other users' reviews and ratings.

Users will be able to find out who else had the same side effects to a health care option and contact those users through the social network. Social EHR will help users keep track of (1) side effects of health care options: (2) the effectiveness of the health care options; and (3) the effectiveness of the different health care optionsby being able to see how others reacted to them. Social EHR may also offer charts that will provide a visual alternative to progress made by the user in different health care options as well as provide a history for the data that the user entered.

Social EHR may also have an Autism Treatment Evaluation Checklist (ATEC) that allows users to view ATEC results and complete ATEC questionnaires. Users can use the ATEC form to help them in measuring treatment effectiveness. It consists of 4 subtests: I. Speech/Language Communication (14 items); II. Sociability (20 items); III. Sensory/Cognitive Awareness (18 items); and IV. Health/Physical/Behavior (25 items). Users of the ATEC may have it scored (4 sub scores and a total score) by entering the responses to the ATEC form on the application for immediate scoring.

Social EHR may further have a Diet module wherein users can add (select), edit or delete diet items (ie. Rice Milk, Chicken, Bananas) that are tracked as part of the user's health care options. The information collected on diet may be arranged in a table format and provide relevant information like name, reviews and ratings, protocol start date, users can collaborate with others by clicking on the social network link associated to the reviews, etc. Users can search diet by name, or by rating or by count of people that reviewed the items. Social EHR will allow users to be able to (1) easily identify which ones are more popular and marked as helpful by the other users and (2) collaborate with others by clicking on the social network link associated to the reviews. Their reviews will be associated with the user social network accounts so others can contact them when needed. Social EHR may have a window that allows the user to see a list the ratings and reviews for any given diet that shows the following information: (1) how many users rated the diet from 1 to 5 stars; (2) the total amount of reviews; (3) the ability to mark reviews as helpful or not helpful; (4) the total amount of people that found a specific review helpful or not helpful; (5) the ability to mark a review as inappropriate and a comment can be added; and (6) the ability to share in their social network timeline or feed or by social network private message reviews for diet. The Social EHR may suggest the most relevant diet for the user's condition. Most relevant is defined by how many reviews, the rating and how many people found the reviews useful. Users will be able to see the history of the social interactions that were made by viewing other users' reviews and ratings.

Social EHR will allow users to keep track of (1) the effectiveness of the diet items and (2) what the effectiveness is of the different diets by being able to see how others reacted to the treatments. Social EHR may help users keep track of side effects of the diet items as well as offer charts that will provide a visual alternative to progress made by the patient in different diets and provides history for the data that the user entered.

Social EHR may also have a place to track and record immunization records. Users can add, edit or delete immunization items and their details can be arranged in a table format to provide relevant information like name, reviews and ratings, administration date, users can collaborate with others by clicking on the social network link associated to the reviews, etc. Social EHR may also provide history for the data that the user entered.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for exchanging personalized electronic health records for a viewing user of a social network, comprising:
a. Storing patient health information by one or more users of a social network;
b. Accessing relationship data for the one or more users, the relationship data specifying medical links between users in the social network;
c. Associating at least one medical link with at least one user to produce consolidated medical data;
d. Aggregating consolidated data having one or more common medical links to produce aggregated consolidated data, wherein the aggregated consolidated data identifies at least one medical link, a user of the social network with the medical link, and one or more other users of the social network who also have the same medical link; and
e. Creating social networking links based on the aggregated consolidated data.

2. The method of claim 1 wherein the medical link is an illness.

3. The method of claim 2 wherein the illness is identified by an ICD9 or ICD10 diagnosis code.

4. The method of claim 1 wherein the medical link is selected from the group comprising a medical treatment, medication, supplement, diet, or medical protocol.

5. The method of claim 4 wherein at least one user tracks the health impact of the medical treatment, medication, supplement, diet or medical protocol.

6. The method of claim 5 wherein other users of the social network may search for users with the desired impact.

7. The method of claim 5 further comprising adding a review for a medical treatment, medication, supplement, diet or medical protocol to the consolidated data wherein at least one user may access said review.

8. The method of claim 1 wherein the medical link is a health care provider's offered or prescribed medical treatments and medications.

9. The method of claim 8 wherein the social networking link created is a list of health care providers matching the desired offered or prescribed medical treatments, supplements and medications.

10. The method of claim 9 further comprising adding a review for the health care provider to the consolidated data wherein at least one user may access said review.

11. The method of claim 6 further comprising:
a. Monitoring an interaction of a viewing user with at least one illness;
b. Suggesting at least one medical treatment, medication, diet or medical protocol based on user input of the impact on the illness.

12. A system for displaying a news feed comprising:
a. A social network environment;
b. A module configured to access relationship data for the one or more users, the relationship data specifying a plurality of medical links between users in the social network environment;
c. A module configured to monitor the plurality of medical links between users in the social network environment;
d. A storage medium for storing the plurality of medical links in a database;
e. A module configured to generate a plurality of news items from one or more medical links, wherein one or more of the medical links is for presentation to one or more viewing users and relates to a medical link that was entered by another user; and
f. A module configured to display a personalized news feed for a user created by identifying at least one action associated with a common medical link, a user of the social network with the common medical link, and one or more other users of the social network who also have the same medical link.

13. The method of claim 12 wherein the medical link is an illness.

14. The method of claim 12 wherein the medical link is selected from the group comprising a medical treatment, medication, supplements, diet, or medical protocol.

15. The method of claim 14 wherein at least one user tracks the impact of the medical treatment, medication, supplements, diet or medical protocol.

16. The method of claim 15 wherein other users of the social network may search for users with the desired impact.

17. The method of claim 12 wherein the medical link is a health care provider's offered or prescribed medical treatments and medications.

18. The method of claim 17 wherein the social networking link created is a list of health care providers matching the desired offered or prescribed medical treatments and medications.

19. A computer readable medium having embodied thereon a program, the program being executable by a processor for performing a method for exchanging personalized electronic health records for a viewing user of a social network, the method comprising:
a. Storing patient health information by one or more users of a social network;
b. Accessing relationship data for the one or more users, the relationship data specifying medical links between users in the social network;
c. Associating at least one medical link with at least one user to produce consolidated medical data;
d. Aggregating consolidated data having one or more common medical links to produce aggregated consolidated data, wherein the aggregated consolidated data identifies at least one medical link, a user of the social network with the medical link, and one or more other users of the social network who also have the same medical link; and
e. Creating social networking links based on the aggregated consolidated data.

20. The computer readable medium of claim 19 further comprising attaching an active link associated with at least one medical link to display a news feed based on common medical links between users.
